(19) United States
(12) Patent Application Publication
(10) Pub. No.: US 2014/0084946 A1
(43) Pub. Date: Mar. 27, 2014

(54) System And Method For Wireless Power And Data Transmission In A Rotary Steerable System

(71) Applicant: SCHLUMBERGER TECHNOLOGY CORPORATION, Sugar Land, TX (US)

(72) Inventors: Brian Oliver Clark, Sugar Land, TX (US); Keith A. Moriarty, Houston, TX (US); Raphael Gadot, Houston, TX (US)

(73) Assignee: SCHLUMBERGER TECHNOLOGY CORPORATION, Sugar Land, TX (US)

(21) Appl. No.: 13/802,746

(22) Filed: Mar. 14, 2013

Related U.S. Application Data
(60) Provisional application No. 61/704,910, filed on Sep. 24, 2012.
(60) Provisional application No. 61/704,805, filed on Sep. 24, 2012.
(60) Provisional application No. 61/704,758, filed on Sep. 24, 2012.

(51) Int. Cl. G01N 27/02

(52) U.S. Cl. CPC G01N 27/02
USPC 324/654

(57) ABSTRACT

Various embodiments for wireless power and data communications transmissions between a cartridge in a rotary steering system and components within a drill collar are disclosed. In a certain embodiment, magnetic fields are used to transfer power and data between the cartridge of a rotary steering system and electronics and/or sensors mounted in the drill collar. A first coil is attached to the pressure housing of the cartridge by a shaft containing wires. The turbine in the pressure housing provides an alternating current to the first coil, which is attached to the shaft. Consequently, the first coil generates an alternating magnetic field that passes through the ferrite surrounding a second coil that is attached by wires to an annular pressure housing that is attached to the drill collar. The alternating magnetic field generates an emf in the second coil, which provides power for electronics and sensors mounted in the drill collar.

### CROSS-REFERENCE TO RELATED APPLICATIONS

This application claims the benefit of and priority to U.S. Provisional Patent Application Ser. No. 61/704,910, entitled “System And Method For Wireless Power And Data Transmission In A Bottom Hole Assembly,” and filed on Sep. 24, 2012, U.S. Provisional Patent Application Ser. No. 61/704,805, entitled “System And Method for Wireless Power And Data Transmission In A Mud Motor,” and filed on Sep. 24, 2012, and U.S. Provisional Patent Application Ser. No. 61/704,758, entitled “Positive Displacement Motor Rotary Steerable System And Apparatus,” and filed on Sep. 24, 2012, the disclosures of which are hereby incorporated by reference in their entireties.

### DESCRIPTION OF THE RELATED ART

Bottom hole assemblies (“BHA”) at the end of a typical drill string used in the drilling and mining industry today may be a complex assembly of technology that includes not only a drill bit, but also an array of serially connected drill string components or tools. The various drill string tools that make up a BHA commonly include a positive displacement motor or “mud motor” as well as other tools such as, but not limited to, tools that include electrically powered systems on a chip (“SoC”) designed to leverage local sensors for the collection, processing and transmission of data that can be used to optimize a drilling strategy. In many cases, the various tools that make up a BHA are in bidirectional communication. One or more of the tools may serve as a power source for one or more of the other tools.

As one might expect, a BHA may be an equipment assembly with a hardened design that can withstand the demands of a drill string. Failure of a BHA, whether mechanically or electrically, inevitably brings about expensive and unwelcomed operating costs as the drilling process may be halted and the drill string retracted from the bore so that the failed BHA can be repaired. In many cases, retraction of a drill string to repair a failed BHA can be very costly.

A common failure point for BHAs is the point of connection from tool to tool, which is naturally prone to failure from adverse fluid ingress and/or misalignment between adjacent tools. While the individual tools may be robust in design, the mechanical and electrical connections between the tools may be a natural “weak point” that often determines the overall reliability of the BHA system.

For instance, in many cases, the transmission of power and/or communications data from a rotary steering system to equipment residing in a drill collar is particularly challenging. In such an application, power and/or communications data transmission via wire can be impractical if not impossible because the drill collar is configured to rotate with respect to the rotary steering system.

### SUMMARY OF THE DISCLOSURE

Various embodiments of methods and systems for wireless power and data communications transmissions between a cartridge of rotary steering system and components within a drill collar are disclosed. The efficient transfer of electrical power between two otherwise weakly coupled coils, such as coils that may respectively reside in a power cartridge of a rotary steering system and a drill collar, can be accomplished in various embodiments that use resonantly tuned circuits and impedance matching techniques. To compensate for the flux leakage, embodiments resonate inductively coupled primary and secondary coils at the same frequency. Further, in some embodiments, the source resistance is matched to the impedance looking toward the load, and the load resistance is matched to the impedance looking toward the source.

In a certain embodiment, magnetic fields are used to transfer power and data between the cartridge of a rotary steering system and electronics and/or sensors mounted in the drill collar. A first coil is attached to the pressure housing of the rotary steering system by a shaft containing wires. The turbine in the pressure housing provides an alternating current to the first coil, which is attached to the shaft. Consequently, the first coil generates an alternating magnetic field that passes through the ferrite surrounding a second coil that is attached by wires to an annular pressure housing that is attached to the drill collar. The alternating magnetic field generates an emf (electromotive force) in the second coil, which provides power for electronics and sensors mounted in the drill collar. Because the magnetic field is azimuthally symmetric, the cartridge and the drill collar can rotate with respect to each other without affecting the magnetic coupling. Furthermore, the position of the first coil relative to the second coil is not critical, and power can be efficiently transferred from the first coil to the second coil even if their relative positions vary slightly.

The mud flow path is in the center of the annular electronics pressure housing, but it then passes through the gap between the first coil and the second coil and flows in the annular space between the pressure housing and the drill collar. Data may be transmitted between the pressure housing and drill collar electronics by modulating the power signal or by adding data coils as previously described.

In another embodiment, sensors in a drill collar may be powered from a retrievable MWD tool. The power transfer uses an inner coil and an outer coil. The inner coil is wound on the outside of the pressure housing of the MWD tool and the outer coil is mounted to the inner diameter wall (“ID”) of the drill collar. The inner and outer coils have ferrite cores. Consequently, power can be efficiently transferred from the inner coil to the outer coil, which allows for sensors in the drill collar to be powered by a turbine or batteries mounted in the bore of the drill collar. Likewise, power can be transferred from the drill collar to electronics mounted inside the drill collar. Data may also be transferred by modulating the frequency, phase, or amplitude of the power carrying signal. A low value for the coupling coefficient may be offset by resonating the two coils at the same frequency, by designing coils with high quality factors, and/or by matching impedances of the source and of the load to the system.

The system described below mentions how power may flow from the rotary steerable system (“RSS”) to the drill collar. One of ordinary skill in the art recognizes that power may easily flow in the other direction—from the drill collar to the RSS. The system may transmit power in either directions and/or in both directions as understood by one of ordinary skill in the art.

This summary is provided to introduce a selection of concepts that are further described below in the detailed description. This summary is not intended to identify key or features of the claimed subject matter, nor is it intended to be used as an aid in limiting the scope of the claimed subject matter.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1A is a diagram of a system for wireless drilling and mining extenders in a drilling operation;

FIG. 1B is a diagram of a wellsite drilling system that forms part of the system illustrated in FIG. 1A;

FIG. 2 is a schematic drawing depicting a primary or transmitting circuit and a secondary or receiving circuit;

FIG. 3 is a schematic drawing depicting a primary or transmitting circuit and a secondary or receiving circuit with transformers having turn ratios N_{S}:1 and N_{L}:1 that may be used to match impedances;

FIG. 4 is a schematic drawing depicting an alternative circuit to that which is depicted in FIG. 3 and having parallel capacitors that are used to resonate the coils' self-inductances;

FIGS. 5A-5B illustrate an embodiment of a transmitting coil inside a receiving coil;

FIGS. 6-7 are graphs illustrating the variation in k versus axial displacement of the transmitting coil when x=0 is small and the transverse displacement when z=0 produces very small changes in k of given embodiments, respectively;

FIGS. 8-9 are graphs illustrating that power efficiency may also be calculated for displacements from the center in the z direction and in the x direction, respectively, of given embodiments;

FIG. 10 is a graph illustrating that the sensitivity of the power efficiency to frequency drifts may be relatively small in some embodiments;

FIG. 11 is a graph illustrating that drifts in the components values of some embodiments do not have a significant effect on the power efficiency of the embodiment;

FIG. 12 depicts a particular embodiment configured to convert input DC power to a high frequency AC signal, f₀, via a DC/AC convertor;

FIG. 13 depicts a particular embodiment configured to pass AC power through the coils;

FIG. 14 depicts a particular embodiment that includes additional secondary coils configured to transmit and receive data;

FIG. 15 depicts a detail view of a rotary steerable system;

FIG. 16 is a cross-sectional view of a rotary steerable system that uses magnetic fields to transfer power and data between the cartridge and electronics and/or sensors mounted in the drill collar;

FIG. 17 is a cross-sectional view of a rotary steerable system that uses magnetic fields and antennas to short-hop communication between an RSS and an MWD tool;

FIG. 18 illustrates an embodiment that uses magnetic fields and antennas to short-hop communication between an RSS and an MWD tool, as depicted and described relative to the FIG. 17 embodiment;

FIG. 19 illustrates an embodiment that uses magnetic fields to short-hop communication between antennas of the RSS and an MWD tool for measurement of a deep resistivity measurement;

FIG. 20 depicts a retrievable MWD tool;

FIG. 21 depicts an embodiment for using magnetic fields to power sensors in a drill collar that contains a retrievable MWD tool; and

FIGS. 22A-22C illustrate detailed views of the inner and outer coil configuration used in the embodiment of FIG. 21.

### DETAILED DESCRIPTION

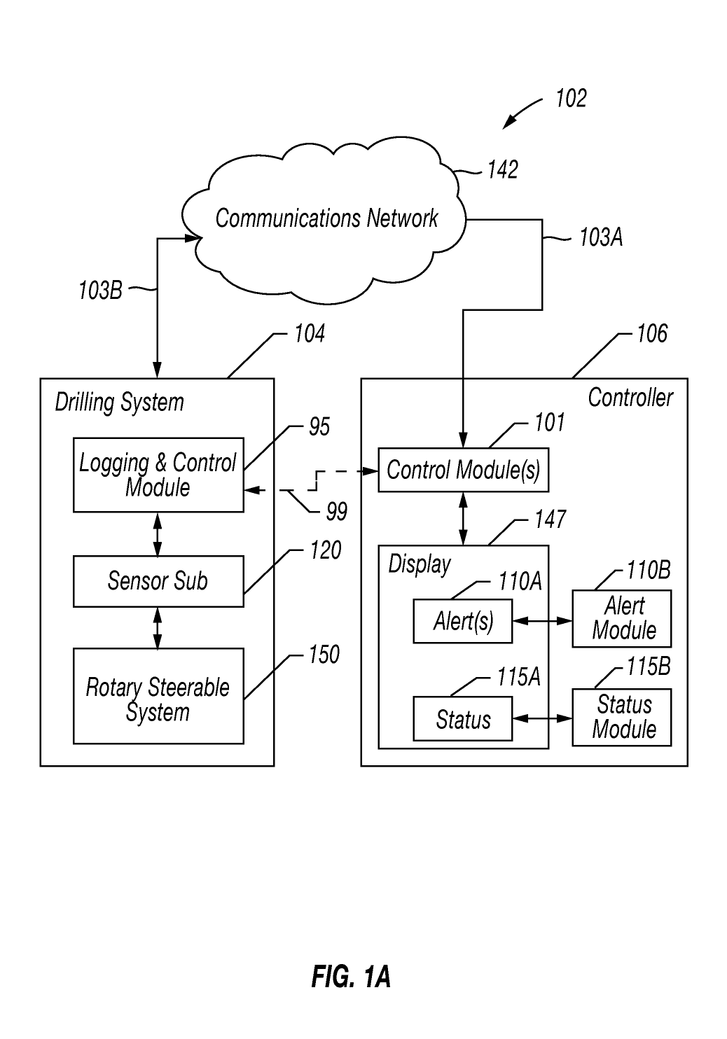

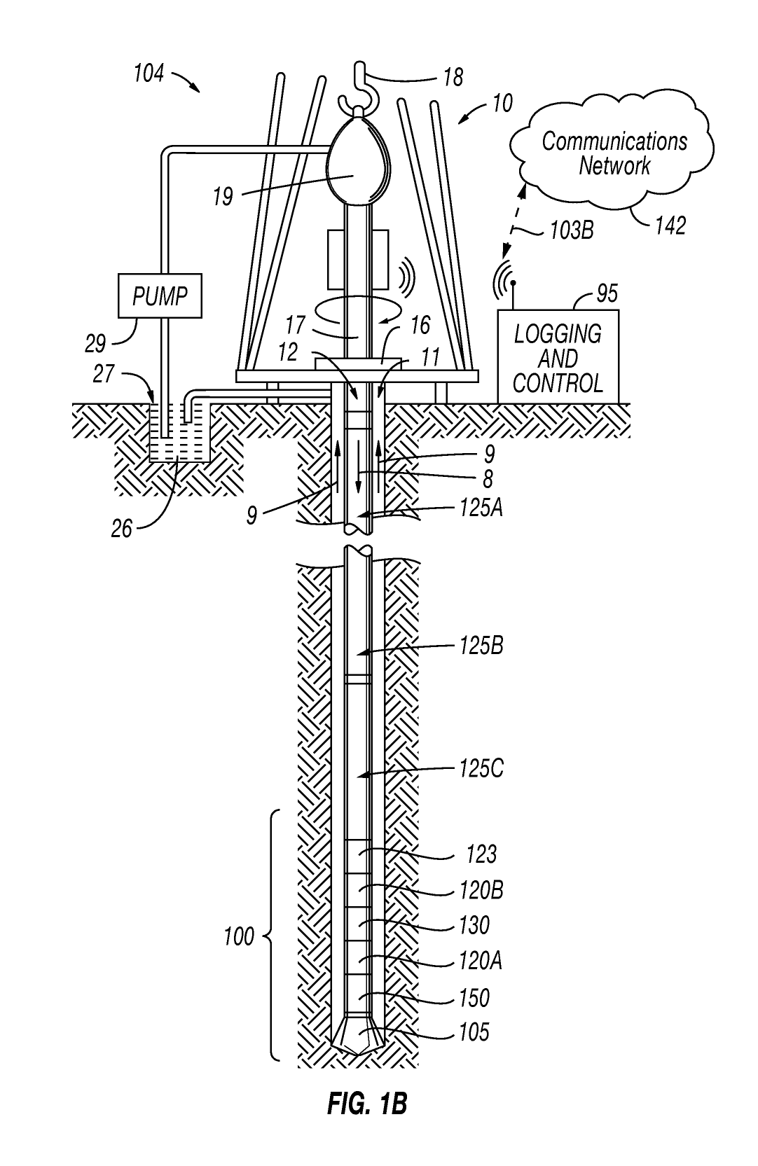

Referring initially to FIG. 1A, this figure is a diagram of a system 102 for controlling and monitoring a drilling operation using refined solutions from a panistic inversion. The system 102 includes a controller module 101 that is part of a controller 106. The system 102 also includes a drilling system 104 which has a logging and control module 95. The controller 106 further includes a display 147 for conveying alerts 110A and status information 115A that are produced by an alerts module 110B and a status module 115B. The controller 106 may communicate with the drilling system 104 via a communications network 142. The system 102 also includes a sensor sub 120 and a rotary steerable system 150, as further described in FIG. 1B.

FIG. 1B illustrates a wellsite drilling system 104 that forms part of the system 102 illustrated in FIG. 1A. The wellsite can be onshore or offshore. In this system 104, a borehole 11 is formed in subsurface formations by rotary drilling in a manner that is known to one of ordinary skill in the art. Embodiments of the system 104 can also use directional drilling, as will be described hereinafter. The drilling system 104 includes the logging and control module 95 as discussed above in connection with FIG. 1A.

A drill string 12 is suspended within the borehole 11 and has a bottom hole assembly (“BHA”) 100 which includes a drill bit 105 at its lower end. The surface system includes platform and derrick assembly 10 positioned over the borehole 11, the assembly 10 including a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, attached to a traveling block (also not shown), through the kelly 17 and a rotary swivel 19 which permits rotation of the drill string 12 relative to the hook 18. As is known to one of ordinary skill in the art, a top drive system could alternatively be used instead of the kelly 17 and rotary table 16 to rotate the drill string 12 from the surface. The drill string 12 may be assembled from a plurality of segments 125 of pipe and/or collars threadedly joined end to end.

In the embodiment of FIG. 1B, the surface system further includes drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole, as indicated by the directional arrows 9. In this system as understood by one of ordinary skill in the art, the drilling fluid 26 lubricates the drill bit 105 and carries formation cuttings up to the surface as it is returned to the pit 27 for cleaning and recirculation.

The bottom hole assembly 100 of the illustrated embodiment may include a logging-while-drilling (LWD) module 120, a measuring-while-drilling (MWD) module 130, a rotary-steerable system and motor 150, and drill bit 105.

The LWD module 120 is housed in a special type of drill collar, as is known to one of ordinary skill in the art, and can contain one or a plurality of known types of logging tools. It will also be understood that more than one LWD 120 and/or MWD module 130 can be employed, e.g. as represented at 120A. (References, throughout, to a module at the position of 120A can alternatively mean a module at the position of 120B as well.) The LWD module 120 includes capabilities for measuring, processing, and storing information, as well as for communicating with the surface equipment. In the present embodiment, the LWD module 120 includes a directional resistivity measuring device.

The MWD module 130 is also housed in a special type of drill collar, as is known to one of ordinary skill in the art, and can contain one or more devices for measuring characteristics of the drill string 12 and drill bit 105. The MWD module 130 may further include an apparatus (not shown) for generating electrical power to the downhole system 100.

This apparatus may include a mud turbine generator powered by the flow of the drilling fluid 26, it being understood by one of ordinary skill in the art that other power and/or battery systems may be employed. In the embodiment, the MWD module 130 includes one or more of the following types of measuring devices: a weight-on-bit measuring device, a torque measuring device, a vibration measuring device, a shock measuring device, a stick slip measuring device, a direction measuring device, and an inclination measuring device.

The foregoing examples of wireline and drill string conveyance of a well logging instrument are not to be construed as a limitation on the types of conveyance that may be used for the well logging instrument. Any other conveyance known to one of ordinary skill in the art may be used, including without limitation, slickline (solid wire cable), coiled tubing, well tractor and production tubing.

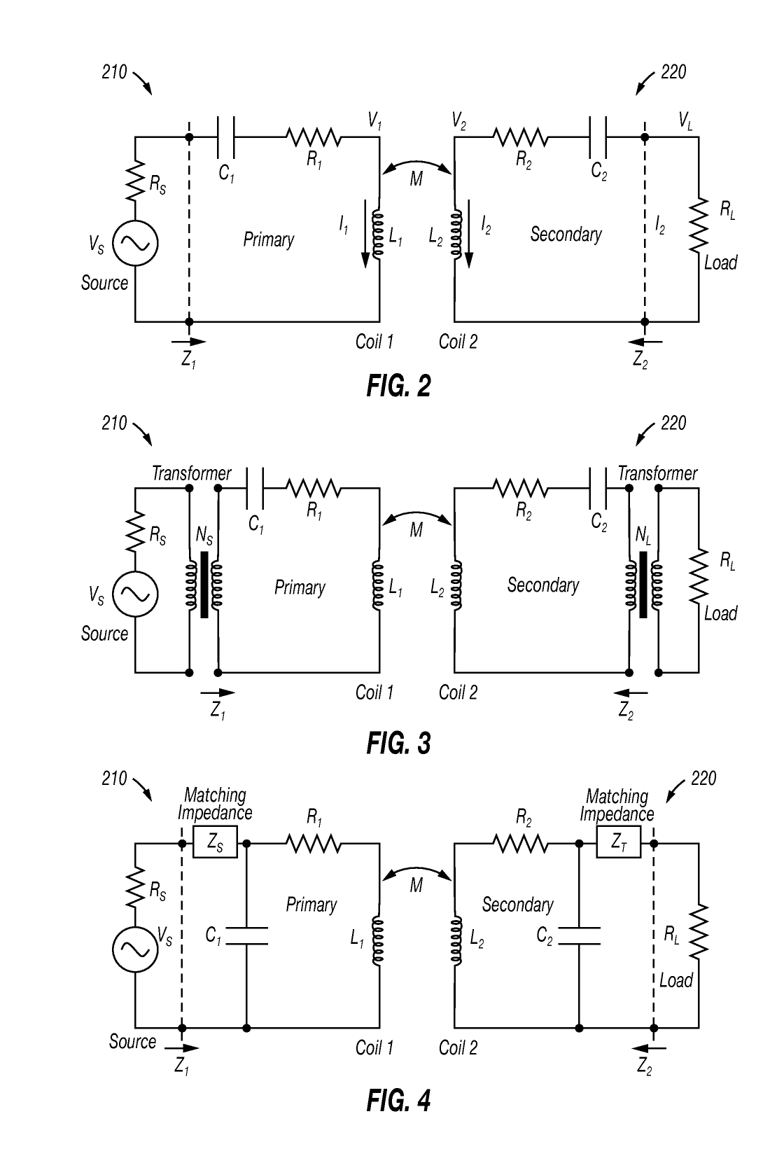

FIG. 2 is a schematic drawing depicting a primary or transmitting circuit 210 and a secondary or receiving circuit 220. In this description, the time dependence is assumed to be exp(jωt) where ω=2πf and f is the frequency in Hertz. Returning to the FIG. 2 illustration, the transmitting coil is represented as an inductance L₁ and the receiving coil as L₂. In the primary circuit 210, a voltage generator with constant output voltage V_{S} and source resistance R_{S} drives a current I₁ through a tuning capacitor C₁ and primary coil having self-inductance L₁ and series resistance R₁. The secondary circuit 220 has self-inductance L₂ and series resistance R₂. The resistances, R₁ and R₂, may be due to the coils' wires, to losses in the coils magnetic cores (if present), and to conductive materials or mediums surrounding the coils. The Emf (electromotive force) generated in the receiving coil is V₂, which drives current I₂ through the load resistance R_{L} and tuning capacitor C₂. The mutual inductance between the two coils is M, and the coupling coefficient k is defined as:

k=M/\sqrt{L₁L₂} (1)

While a conventional inductive coupler has k≈1, weakly coupled coils may have a value for k less than 1 such as, for example, less than or equal to about 0.9. To compensate for weak coupling, the primary and secondary coils in the various embodiments are resonated at the same frequency. The resonance frequency is calculated as:

$${ω}_{0} = \frac{1}{\sqrt{{L}_{1} {C}_{1}}} = \frac{1}{\sqrt{{L}_{2} {C}_{2}}} \qquad ( 2 )$$

At resonance, the reactance due to L₁ is cancelled by the reactance due to C₁. Similarly, the reactance due to L₂ is cancelled by the reactance due to C₂. Efficient power transfer may occur at the resonance frequency, f₀=ω₀/2π. In addition, both coils may be associated with high quality factors, defined as:

$${Q}_{1} = \frac{ω {L}_{1}}{{R}_{1}} \\ and \\ {Q}_{2} = \frac{ω {L}_{2}}{{R}_{2}} . \qquad ( 3 )$$

The quality factors, Q, may be greater than or equal to about 10 and in some embodiments greater than or equal to about 100. As is understood by one of ordinary skill in the art, the quality factor of a coil is a dimensionless parameter that characterizes the coil's bandwidth relative to its center frequency and, as such, a higher Q value may thus indicate a lower rate of energy loss as compared to coils with lower Q values.

If the coils are loosely coupled such that k<1, then efficient power transfer may be achieved provided the figure of merit, U, is larger than one such as, for example, greater than or equal to about 3:

U=k\sqrt{Q₁Q₂>>1}. (4)

The primary and secondary circuits are coupled together via:

V₁=jωL₁I₁+jωMI₂ and V₂=jωL₂I₂+jωMI₁, (5)

where V₁ is the voltage across the transmitting coil. Note that the current is defined as clockwise in the primary circuit and counterclockwise in the secondary circuit. The power delivered to the load resistance is:

$${P}_{L} = \frac{1}{2} {R}_{L} {\vert {I}_{2} \vert}^{2} , \qquad ( 6 )$$

while the maximum theoretical power output from the fixed voltage source V_{S} into a load is:

$${P}_{MAX} = \frac{{\vert {V}_{S} \vert}^{2}}{8 {R}_{S}} . \qquad ( 7 )$$

The power efficiency is defined as the power delivered to the load divided by the maximum possible power output from the source,

$$η ≡ \frac{{P}_{L}}{{P}_{MAX}} . \qquad ( 8 )$$

In order to optimize the power efficiency, η, the source resistance may be matched to the impedance of the rest of the circuitry. Referring to FIG. 2, Z₁ is the impedance looking from the source toward the load and is given by:

$${Z}_{1} = {R}_{1} - j / ( ω {C}_{1} ) + jω {L}_{1} + \frac{{ω}^{2} {M}^{2}}{{R}_{2} + {R}_{L} + jω {L}_{2} - j / ( ω {C}_{2} )} \qquad ( 9 )$$

When ω=ω₀, Z₁ is purely resistive and may equal R_{S} for maximum efficiency.

$${Z}_{1} = {R}_{1} + \frac{{ω}^{2} {M}^{2}}{{R}_{2} + {R}_{L}} ≡ {R}_{S} . \qquad ( 10 )$$

Similarly, the impedance seen by the load looking back toward the source is

$${Z}_{2} = {R}_{2} - j / ( ω {C}_{2} ) + jω {L}_{2} + \frac{{ω}^{2} {M}^{2}}{{R}_{1} + {R}_{S} + jω {L}_{1} - j / ( ω {C}_{1} )} \qquad ( 11 )$$

When ω=ω₀, Z₂ is purely resistive and R_{L} should equal Z₂ for maximum efficiency

$${Z}_{2} = {R}_{2} + \frac{{ω}^{2} {M}^{2}}{{R}_{1} + {R}_{S}} ≡ {R}_{L} . \qquad ( 12 )$$

The power delivered to the load is then:

$${P}_{L} = \frac{1}{2} \frac{{R}_{L} {ω}_{0}^{2} {M}^{2} {\vert {V}_{S} \vert}^{2}}{{[ ( {R}_{S} + {R}_{1} ) ( {R}_{2} + {R}_{L} ) + {ω}_{0}^{2} {M}^{2} ]}^{2}} , \qquad ( 13 )$$

and the power efficiency is the power delivered to the load divided by the maximum possible power output,

$$η ≡ \frac{{P}_{L}}{{P}_{MAX}} = \frac{4 {R}_{S} {R}_{L} {ω}_{0}^{2} {M}^{2}}{{[ ( {R}_{S} + {R}_{1} ) ( {R}_{2} + {R}_{L} ) + {ω}_{0}^{2} {M}^{2} ]}^{2}} . \qquad ( 14 )$$

The optimum values for R_{L} and R_{L} may be obtained by simultaneously solving

$${R}_{S} = {R}_{1} + \frac{{ω}^{2} {M}^{2}}{{R}_{2} + {R}_{L}} \\ and \\ {R}_{L} = {R}_{2} + \frac{{ω}^{2} {M}^{2}}{{R}_{1} + {R}_{S}} , \qquad ( 15 )$$

with the result that:

R_{S}=R₁\sqrt{1+k²Q₁Q₂} and R_{L}=R₂\sqrt{1+k²Q₁Q₂}. (16)

If the source and load resistances do not satisfy equations (16), then it is envisioned that standard methods may be used to transform the impedances. For example, as shown in the FIG. 3 illustration, transformers with turn ratios N_{S}:1 and N_{L}:1 may be used to match impedances as per equations (16). Alternatively, the circuit illustrated in FIG. 4 may be used. In such an embodiment in FIG. 4, parallel capacitors are used to resonate the coils' self-inductances according to equation (2). As before, Z₁ is defined as the impedance seen by the source looking toward the load, while Z₂ is defined as the impedance seen by the load looking toward the source. In addition, there are two matching impedances, Z_{S} and Z_{T} which may be used to cancel any reactance that would otherwise be seen by the source or load. Hence Z₁ and Z₂ are purely resistive with the proper choices of Z_{S} and Z_{T}. Notably, the source resistance R_{S} may equal Z₁, and the load resistance R_{L} may equal Z₂. The procedures for optimizing efficiency with series capacitance or with parallel capacitance may be the same, and both approaches may provide high efficiencies.

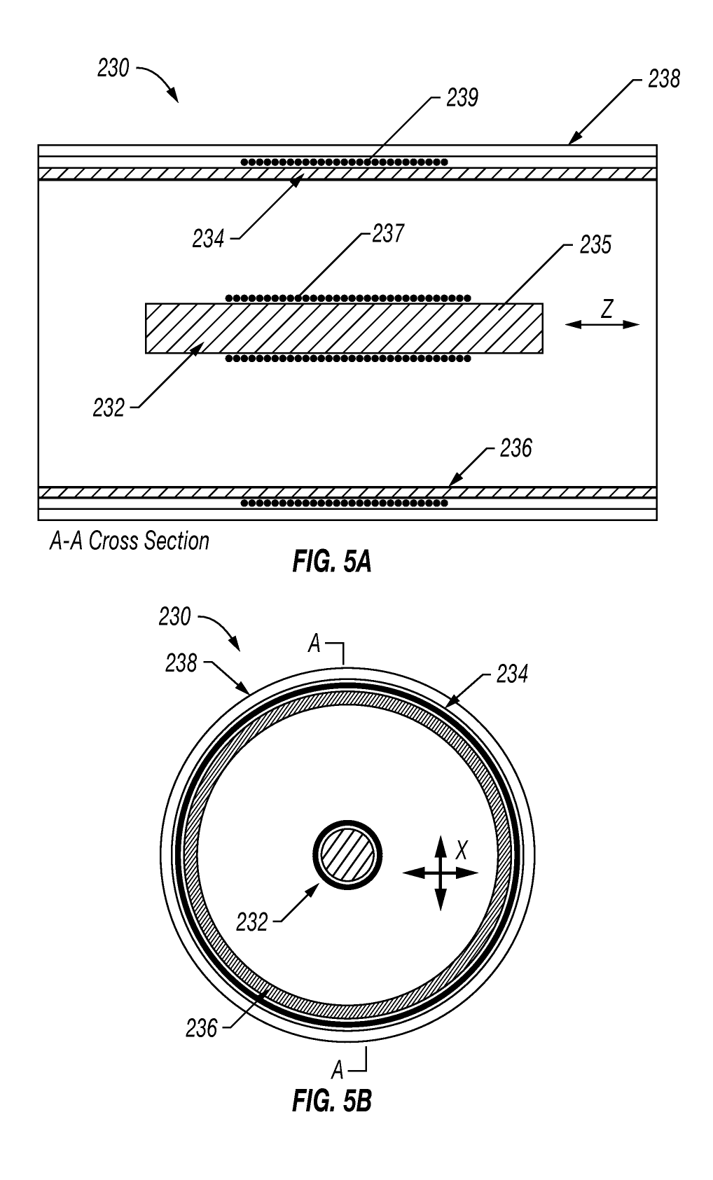

Turning now to FIGS. 5A and 5B, a cross sectional view of two coils 232, 234 is illustrated in FIG. 5A and a side view of the two coils 232, 234 is illustrated in FIG. 5B. In these two figures, a transmitting coil 232 inside a receiving coil 234 of a particular embodiment 230 is depicted. The transmitting coil 232 includes a ferrite rod core 235 that, in some embodiments, may be about 12.5 mm (about 0.49 inch) in diameter and about 96 mm (about 3.78 inches) long with about thirty-two turns of wire 237. Notably, although specific dimensions and/or quantities of various components may be offered in this description, it will be understood by one of ordinary skill in the art that the embodiments are not limited to the specific dimensions and/or quantities described herein.

Returning to FIG. 5, the receiving coil 234 may include an insulating housing 236, about twenty-five turns of wire 239, and an outer shell of ferrite 238. The wall thickness of the ferrite shell 238 in the FIG. 5 embodiment may be about 1.3 mm (about 0.05 inch). In certain embodiments, the overall size of the receiving coil 234 may be about 90 mm (about 3.54 inch) in diameter by about 150 mm (about 5.90 inches) long. The transmitting coil 232 may reside inside the receiving coil 234, which is annular.

The transmitting coil 232 may be free to move in the axial (z) direction or in the transverse direction (x) with respect to the receiving coil 234. In addition, the transmitting coil 232 may be able to rotate on axis with respect to the receiving coil 234. The region between the two coils 232, 234 may be filled with air, fresh water, salt water, oil, natural gas, drilling fluid (known as “mud”), or any other liquid or gas. The receiving coil 234 may also be mounted inside a metal tube, with minimal affect on the power efficiency because the magnetic flux may be captured by, and returned through, the ferrite shell 238 of the receiving coil 234.

The operating frequency for these coils 232, 234 may vary according to the particular embodiment, but, for the FIG. 5 example 230, a resonant frequency f=100 kHz may be assumed. At this frequency, the receiving coil 234 properties are: L₁=6.76·10⁻⁵ Henries and R₁=0.053 ohms, and the transmitting coil 232 properties are L₂=7.55·10⁻⁵ Henries and R₂=0.040 ohms. The tuning capacitors are C₁=3.75·10⁻⁸ Farads and C₂=3.36·10⁻⁸ Farads. Notably, the coupling coefficient k value depends on the position of the transmitting coil 232 inside the receiving coil 234. The transmitting coil 232 is centered when x=0 and z=0, where k=0.64.

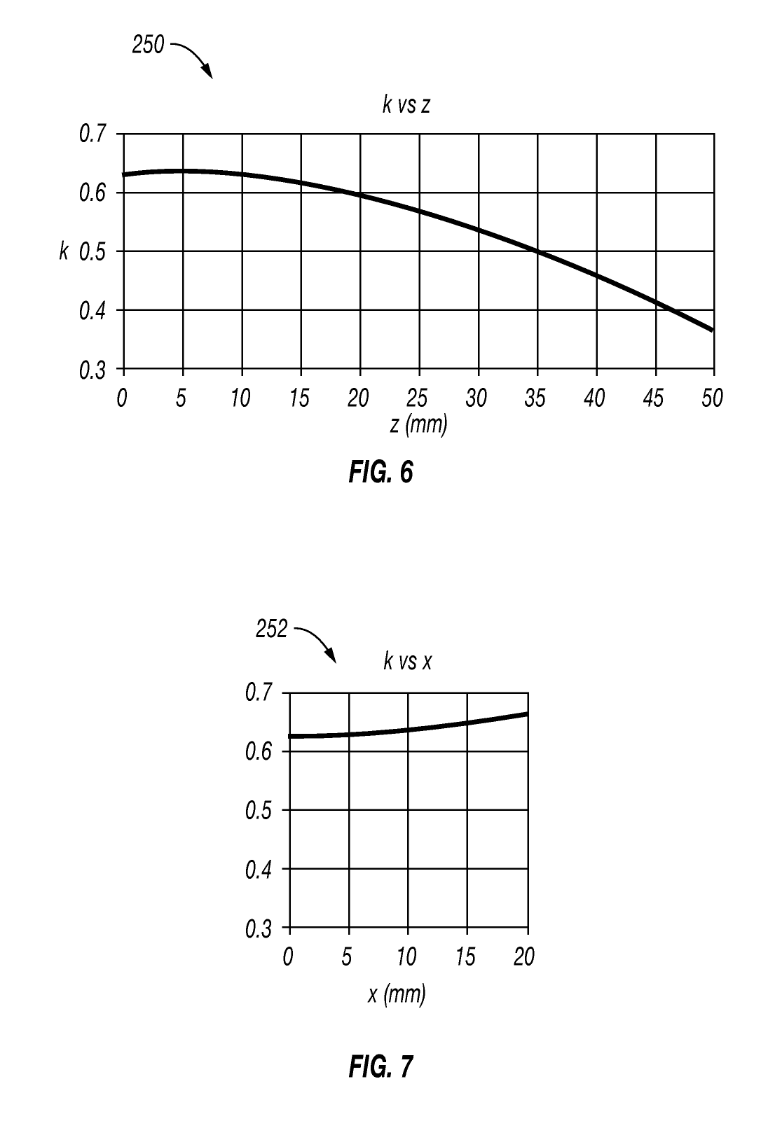

The variation in k versus axial displacement of the transmitting coil 232 when x=0 may be relatively small, as illustrated by the graph 250 in FIG. 6. The transverse displacement when z=0 may produce very small changes ink, as illustrated by the graph 252 in FIG. 7. The transmitting coil 232 may rotate about the z-axis without affecting k because the coils are azimuthally symmetric. According to equations (16), an optimum value for the source resistance may be R_{S}=32 ohms, and for the load resistance may be R_{L}=24 ohms when the transmitting coil 232 is centered at x=0 and z=0. The power efficiency may thus be η=99.5%.

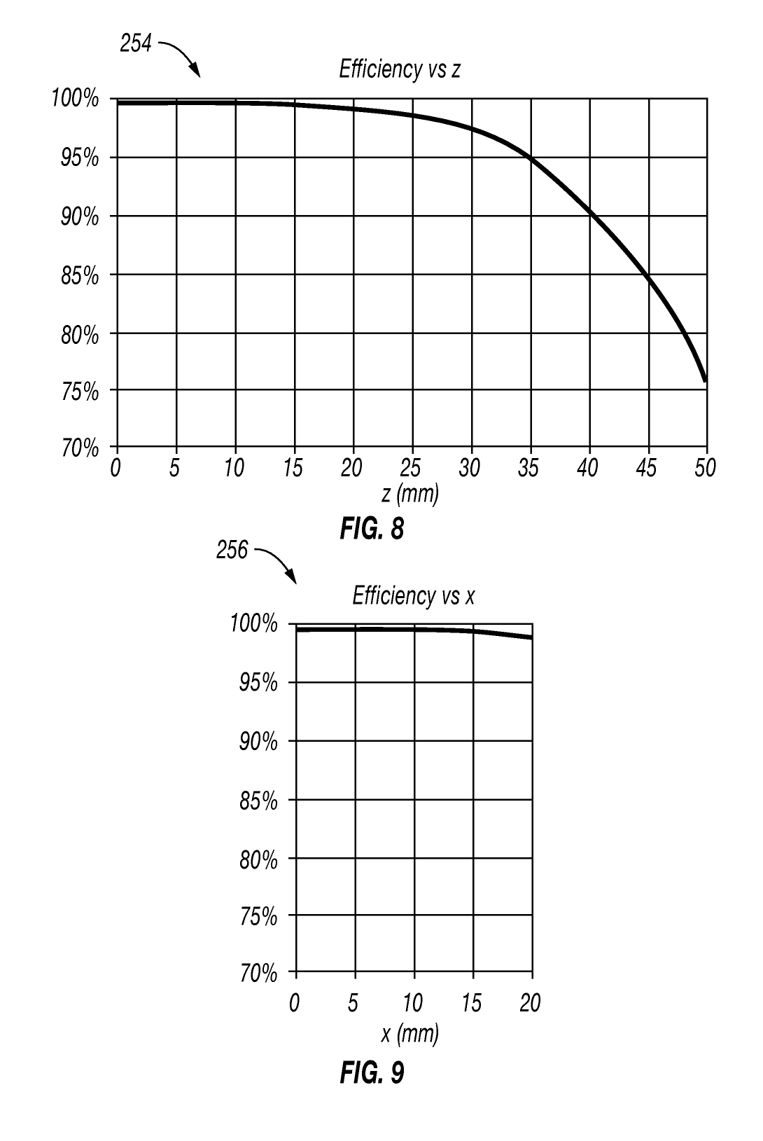

The power efficiency may also be calculated for displacements from the center in the z direction in mm (as illustrated by the graph 254 in FIG. 8) and in the x direction in mm (as illustrated by the graph 256 in FIG. 9). It is envisioned that the efficiency may be greater than about 99% for axial displacements up to about 20.0 mm (about 0.79 inch) in certain embodiments, and greater than about 95% for axial displacements up to about 35.0 mm (about 1.38 inches). It is further envisioned that the efficiency may be greater than 98% for transverse displacements up to 20.0 mm (about 0.79 inch) in some embodiments. Hence, the position of the transmitting coil 232 inside the receiving coil 234 may vary in some embodiments without reducing the ability of the two coils 232, 234 to efficiently transfer power.

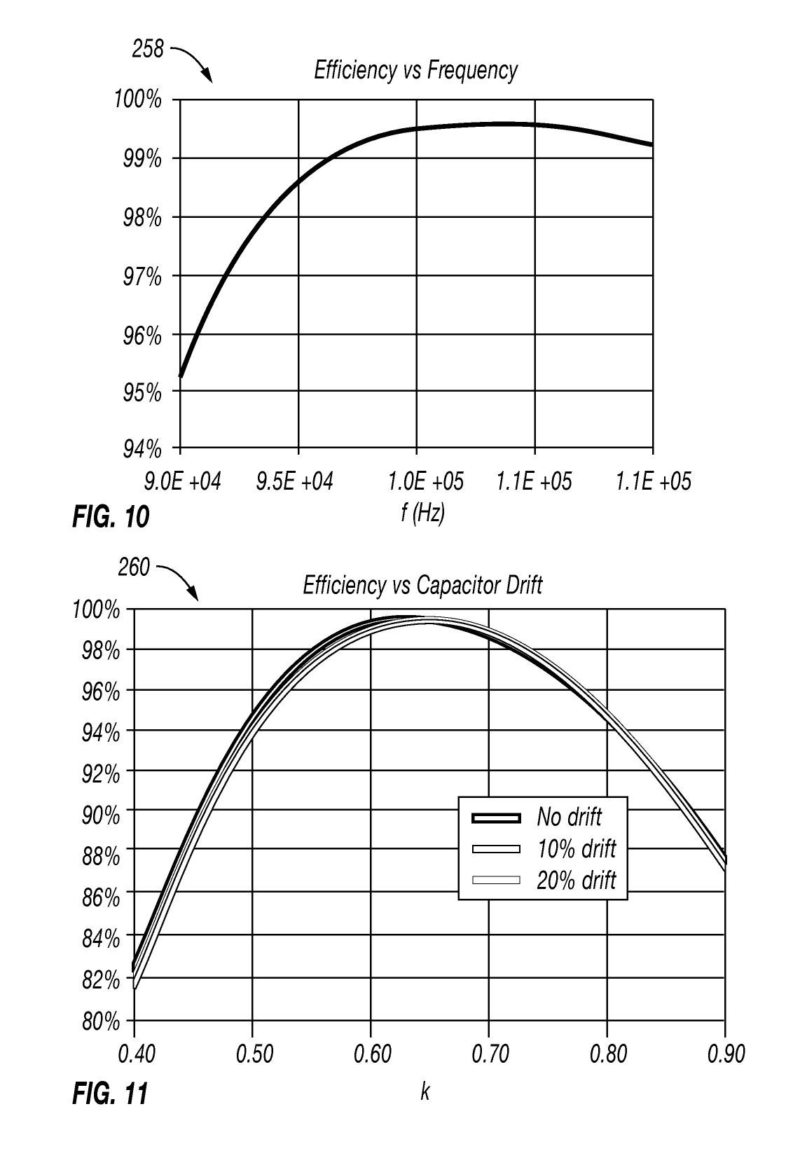

Referring now to FIG. 10, it can be seen in the illustrative graph 258 where the Y-axis denotes efficiency in percentage and the X-axis denotes frequency in Hz that the sensitivity of the power efficiency to frequency drifts may be relatively small. A±10% variation in frequency may produce minor effects, while the coil parameters may be held fixed. The power efficiency at 90,000 Hz is better than about 95%, and the power efficiency at 110,000 Hz is still greater than about 99%. Similarly, drifts in the component values may not have a large effect on the power efficiency. For example, both tuning capacitors C₁ and C₂ are allowed to increase by about 10% and by about 20% as illustrated in the graph 260 of FIG. 11. Notably, the other parameters are held fixed, except for the coupling coefficient k. The impact of the power efficiency is negligible. As such, the system described herein would be understood by one of ordinary skill in the art to be robust.

It is also envisioned that power may be transmitted from the outer coil to the inner coil of particular embodiments, interchanging the roles of transmitter and receiver. It is envisioned that the same power efficiency would be realized in both cases.

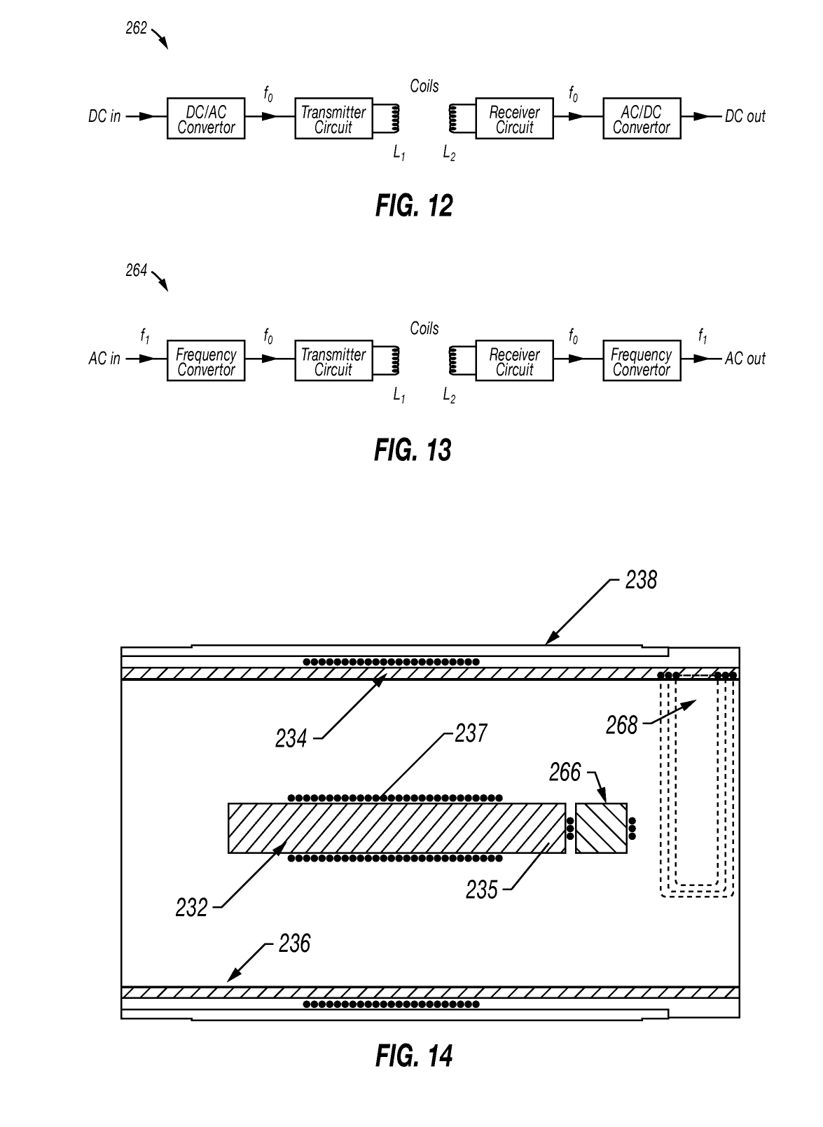

Referring to FIG. 12, an electronic configuration 262 is illustrated for converting input DC power to a high frequency AC signal, f₀, via a DC/AC convertor. The transmitter circuit in the configuration 262 excites the transmitting coil at resonant frequency f₀. The receiving circuit drives an AC/DC convertor, which provides DC power output for subsequent electronics. This system 262 is appropriate for efficient passing DC power across the coils.

Turning to FIG. 13, AC power can be passed through the coils. Input AC power at frequency f₁ is converted to resonant frequency f₀ by a frequency convertor. Normally this would be a step up convertor with f₀>>f₁. The receiver circuit outputs power at frequency f₀, which is converted back to AC power at frequency f₁. Alternatively, as one of ordinary skill in the art recognizes, the FIG. 13 embodiment 264 could be modified to accept DC power in and produce AC power out, and vice versa.

In lieu of, or in addition to, passing power, data signals may be transferred from one coil to the other in certain embodiments by a variety of means. In the above example, power is transferred using an about 100.0 kHz oscillating magnetic field. It is envisioned that this oscillating signal may also be used as a carrier frequency with amplitude modulation, phase modulation, or frequency modulation used to transfer data from the transmitting coil to the receiving coil. Such would provide a one-way data transfer.

An alternative embodiment includes additional secondary coils to transmit and receive data in parallel with any power transmissions occurring between the other coils described above, as illustrated in FIG. 14. Such an arrangement may provide two-way data communication in some embodiments. The secondary data coils 268, 266 may be associated with relatively low power efficiencies of less than about 10%. It is envisioned that in some embodiments the data transfer may be accomplished with a good signal to noise ratio, for example, about 6.0 dB or better. The secondary data coils 268, 266 may have fewer turns than the power transmitting 232 and receiving coils 234.

The secondary data coils 268, 266 may be orthogonal to the power coils 232, 234, as illustrated in FIG. 14. For example, the magnetic flux from the power transmitting coils 232, 234 may be orthogonal to a first data coil 266, so that it does not induce a signal in the first data coil 266. A second data coil 268 may be wrapped as shown in FIG. 14 such that magnetic flux from the power transmitters does not pass through it, but magnetic flux from first data coil 266 does. Notably, the configuration depicted in FIG. 14 is offered for illustrative purposes only and is not meant to suggest that it is the only configuration that may reduce or eliminate the possibility that a signal will be induced in one or more of the data coils by the magnetic flux of the power transmitting coils. Other data coil configurations that may minimize the magnetic flux from the power transmitter exciting the data coils will occur to those with ordinary skill in the art.

Moreover, it is envisioned that the data coils 268, 266 may be wound on a non-magnetic dielectric material in some embodiments. Using a magnetic core for the data coils 268, 266 might result in the data coils' cores being saturated by the strong magnetic fields used for power transmission. Also, the data coils 268, 266 may be configured to operate at a substantially different frequency than the power transmission frequency. For example, if the power is transmitted at about 100.0 kHz in a certain embodiment, then the data may be transmitted at a frequency of about 1.0 MHz or higher. In such an embodiment, high pass filters on the data coils 268, 266 may prevent the about 100.0 kHz signal from corrupting the data signal. In still other embodiments, the data coils 268, 266 may simply be located away from the power coils 232, 234 to minimize any interference from the power transmission. It is further envisioned that some embodiments may use any combination of these methods to mitigate or eliminate adverse effects on the data coils 268, 266 from the power transmission of the power coils 232, 234.

### Application to a Rotary Steerable System

As described above, in drilling and mining applications, sensors and electronics are integrated into drill collars to control the drilling process, to provide information about the drilling process, and to determine the properties of the subsurface formations being penetrated. Such drilling equipment or tools are variously known as Measurement While Drilling (“MWD”), Logging While Drilling (“LWD”), and Directional Drilling (“DD”) equipment. MWD, LWD, and DD equipment having sensors and electrical components require the ability to bi-directionally communicate power and information among themselves. Mechanical or other constraints, however, often limit the ability to run wires from one such device to another.

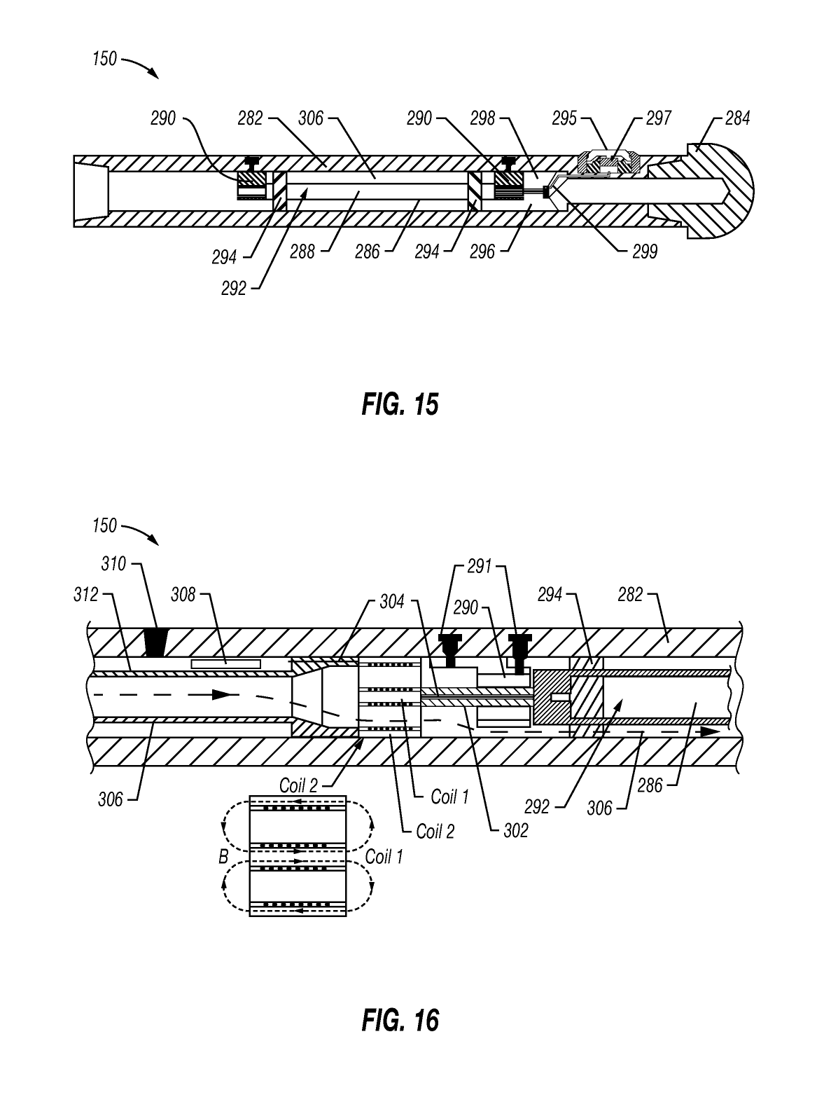

FIG. 15 illustrates a rotary steerable system (“RSS”) 150 in which power may be transmitted from an electronics cartridge 292 to a drill collar 282. The rotary steerable system 150 may be used to drill wells while steering the drill bit 284 in a desired direction as understood by one of ordinary skill in the art. One of ordinary skill in the art recognizes that the system 150 may be used to drill directional wells, deviated wells, extended reach well, and/or horizontal wells. The RSS 150 may be used to drill a straight hole or a curved hole, and may point the bottom hole assembly (“BHA”) in any direction and/or inclination. A directional driller may send a command down to instruct the rotary steerable system 150 to drill in a specific direction and with a specific inclination, which is executed by the rotary steerable system 150.

The rotary steerable system 150 has a pressure housing 286 containing electronics 288 that is mounted on marine bearings 290 inside a drill collar 282. The marine bearings 290 are attached to drill collar 282 with bolts 291. The bearings 290 may permit the cartridge 292 to rotate freely with regard to the drill collar 282. The pressure housing 286 may contain any number of control electronics 288 including, but not necessarily limited to, magnetometers, inclinometers, a turbine, a processor and various other electronics. Torquer blades 294 may be mounted on the pressure housing 286 and used to control the tool face (i.e., the orientation of the cartridge 292 with respect to vertical or a downward direction). The blades 294 may also provide electrical power by driving a turbine, as understood by one of ordinary skill in the art. To steer the well, a drive shaft 296 may be attached to the pressure housing 286. The drive shaft 296 may control a spider valve 298 that includes a small disk with an opening suitable to allow drilling fluid (“mud”) to enter a series of hydraulic tubes 299.

In the rotary steerable system 150, there may be three hydraulic tubes 299 arranged at 120 degree intervals. Each hydraulic tube 299 may connect to a hydraulic piston 297, which in turn pushes against a hinged pad 295. As understood by one of ordinary skill in the art, when a spider valve 298 allows mud to enter one hydraulic tube 299, a corresponding piston 297 may be energized and thereby cause exertion of a strong sideways force on the RSS 150 via an actuation of the hinged pad 295. Because the other two pads in the 120 degree arrangement may remain closed, actuation of the given hinged pad 295 may operate to deflect the drill bit 284 in a direction substantially opposite to that of the actuated hinged pad 295.

Notably, to drill a curved borehole in a particular direction, the spider valve 298 may activate the hinged pad 295 that is located on a side of the RSS 150 that is substantially opposite to the desired direction. Because the pressure housing 286 may be held stationary by the torque blades 294 as described above, i.e. stationary with respect to tool face, the spider valve 298 opening may be maintained in substantially the same position. Meanwhile as the drill collar 282 continues to rotate, the three pads 295 may alternately open and shut as the corresponding hydraulic tubes 299 pass by the spider valve 298 opening. As such, to drill a straight borehole, the pressure housing 286 may rotate at a low RPM so that the spider valve 298 opening continually rotates and the average direction of the side forces exerted from the pads 295 effectively average to zero.

The cartridge 292 may generate its electrical power from a turbine and alternator driven by drilling mud flowing past the cartridge. The cartridge's power supply may be used to power sensors, antennas, and electronics mounted in the drill collar 282. However, because the drill collar 282 rotates with respect to the cartridge 292, it is not possible to simply run wires from the cartridge 292 to the drill collar 282. One option might be to use slip rings to connect the cartridge 292 and the drill collar 282. However, use of slip rings in such an application is complex and unreliable for at least the reason that the slip rings must be maintained in an oil-filled environment with rotating O-ring seals. Furthermore, such a slip ring arrangement may reduce the reliability of a rotary steerable system.

Turning now to FIG. 16, a cross-sectional view of an embodiment of an RSS 150 for transferring power and data between the cartridge 292 and electronics and/or sensors mounted in the drill collar 282 through the use of magnetic fields is depicted. Coil 1 is attached to the pressure housing 286 by a shaft 302 containing wires. As understood by understood by one of ordinary skill in the art, the turbine (not shown) in the pressure housing 286 provides an alternating current to Coil 1, which is attached to the shaft 302. Thus, Coil 1 may generate an alternating magnetic field B that passes through the ferrite surrounding Coil 2.

The alternating magnetic field may generate an emf (electromotive force) in Coil 2, which provides power for electronics 308 and sensors 310 mounted in the drill collar 282. Coil 2 may be attached by wires 304 to an annular pressure housing that is attached to the drill collar 282. Notably, because the magnetic field B may be azimuthally symmetric, the cartridge 292 and the drill collar 282 may rotate with respect to each other without affecting the magnetic coupling. Furthermore, as described previously, the position of Coil 1 relative to Coil 2 is not critical and, as such, power may be efficiently transferred from Coil 1 to Coil 2 even if their relative positions vary.

The mud flow path 306 may be in the center of the annular electronics pressure housing 312 before passing through a gap between Coil 1 and Coil 2 and flowing in the annular space between the pressure housing 286 and the drill collar 282. Notably, data may be transmitted between the pressure housing 286 and drill collar electronics 308 by modulating the power signal or by adding data coils as previously described. The sensors 310 mounted in the drill collar 282 wall may include, but are not limited to including: a borehole pressure sensor, a sensor to measure the weight on bit, a sensor to measure the torque on bit, a gamma-ray detector with azimuthal sensitivity, a resistivity sensor, among other possibilities. The positions of hinged pads 295 (see FIG. 15) may also be measured by proximity sensors mounted in the drill collar 282.

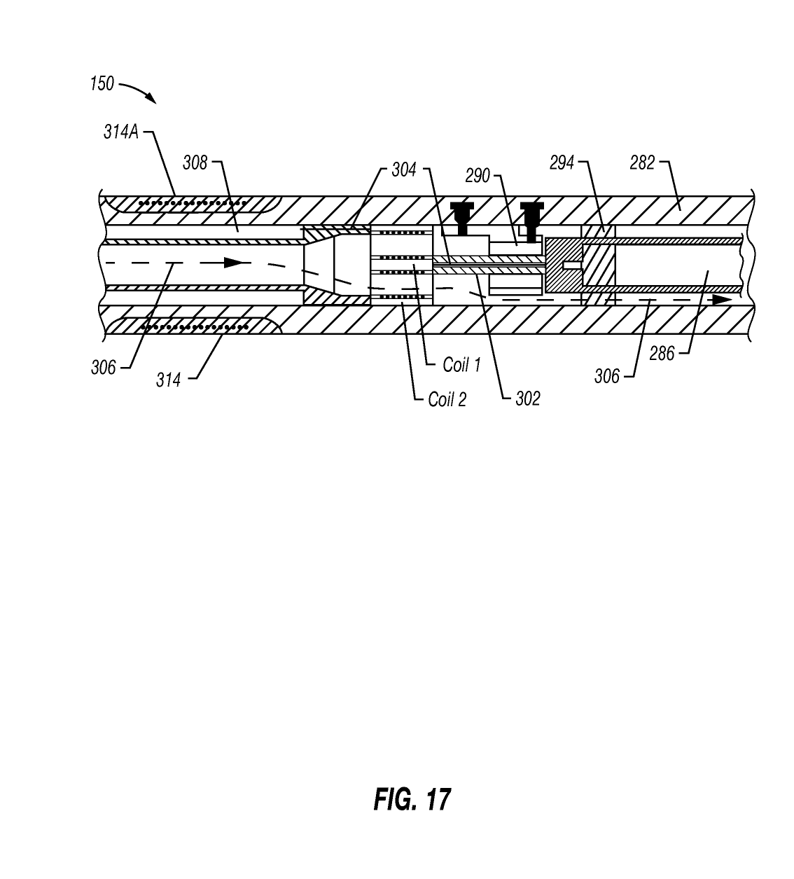

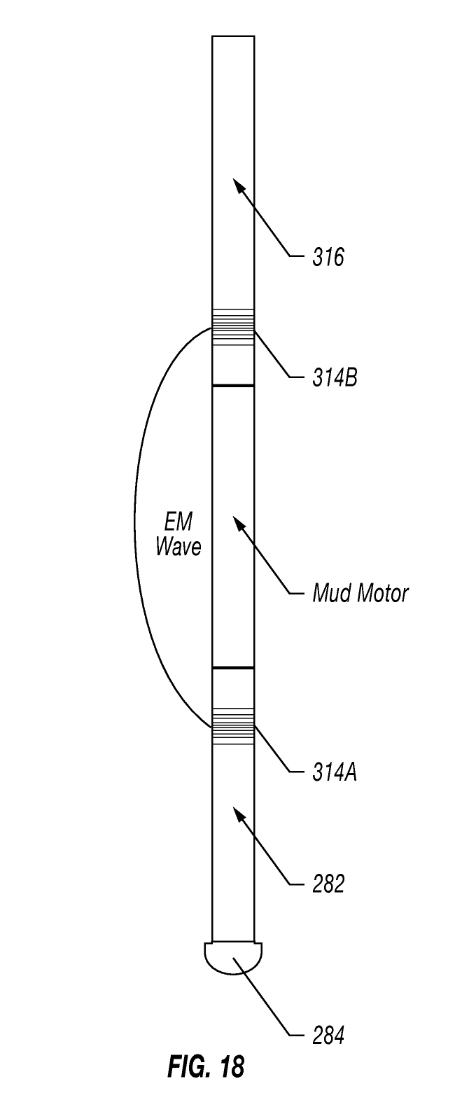

Referring to FIG. 17, it is envisioned that embodiments may be leveraged to short-hop communication between the RSS 150 and an MWD 316 tool. An antenna 314A that includes a multi-turn coil may be mounted in a groove in the exterior of the drill collar 282. A complimentary antenna 314B may be attached to the MWD 316 tool as illustrated in FIG. 18. The distance between the two coils 314 may range from 50 to 100 feet, although other distances are envisioned. The two antennas 314 may transmit and receive electromagnetic (EM) waves at frequencies between about 500 Hz and about 50 kHz, although embodiments within the scope of this disclosure are not limited to such a frequency range. Returning to FIG. 17, transmitting and receiving electronics mounted in the annular electronics section 308 near the antenna 314A may be powered by a turbine in the pressure housing 286 via Coil 1 and Coil 2, as described above. FIG. 18 depicts the electromagnetic telemetry between the short hop antenna 314A on the drill collar 282 and an antenna 314B on the MWD tool 316.

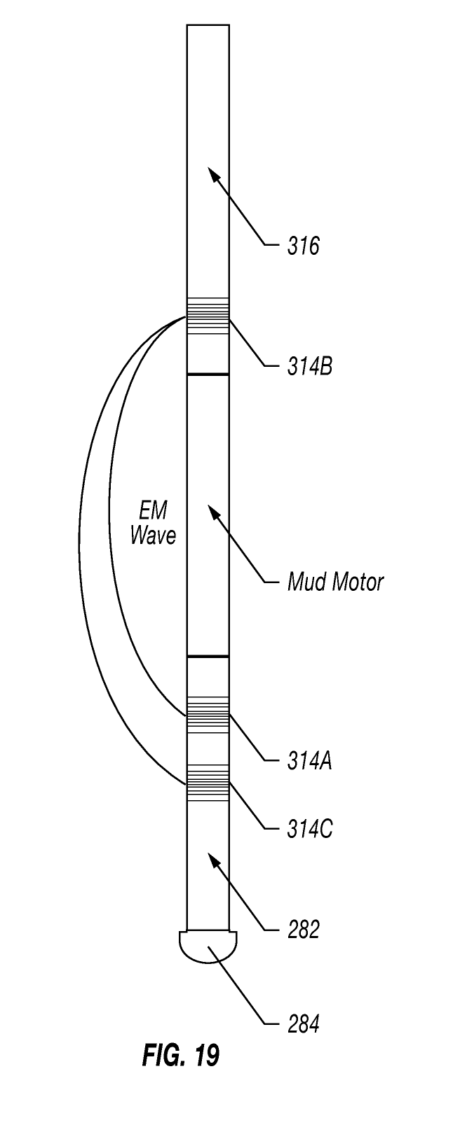

Referring to FIG. 19, another application envisioned for antenna embodiments such as of the type of antennas shown in FIGS. 17 and 18 includes a deep resistivity measurement. Multiple antennas 314, such as antennas 314A and 314C may reside on the drill collar 282 in some embodiments, although other embodiments may include only a single antenna 314A. With a single antenna 314A, the electromagnetic wave attenuation between the MWD 316 antenna 314B and the RSS 150 antenna 314A may correspond to the formation resistivity laterally away from the drill collars. With two antennas 314A, 314C on the RSS 150 drill collar 282, the phase shift and the attenuation between the two antennas can likewise be used to determine the deep formation resistivity. It is further envisioned that antennas 314 with tilted coils and/or transverse coils may also be powered as described above for the axial antenna coils.

### Application to Retrievable MWD Tools

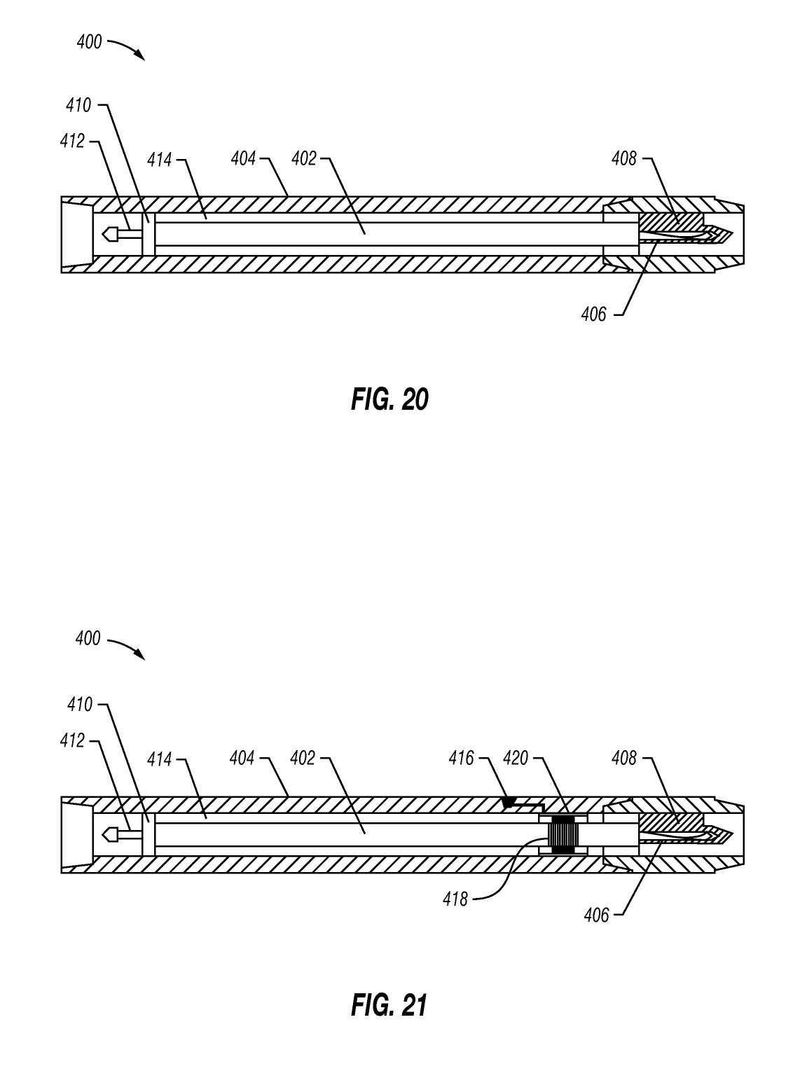

Referring to FIG. 20, a retrievable MWD tool 400 is depicted. The retrievable MWD tool 400 may be contained within a pressure housing 402 that fits into a drill collar 404 such that a mud flow channel 414 is defined in the annular space between the outer diameter of the pressure housing 402 and the inner diameter of the drill collar 404. Notably, the outer diameter (“OD”) of the pressure housing 402 may be about 1.75 inches (about 4.45 cm) in some embodiments, although other pressure housing sizes are envisioned. Moreover, in some embodiments, the pressure housing 402 may be suitable for insertion into various drill collars. The pressure housing 402 may contain any number of devices including, but not limited to, batteries, electronics, processors, sensors, and an actuator for a mud pulser. The bottom of the MWD tool 400 may have a metal orienting stinger 406 that fits into a shoe 408 mounted in a drill collar 404. The shoe 408 and the orienting stinger 406 may work together to determine the axial position of the MWD tool 400, centralize it in the drill collar 404, and control its angular orientation.

Near the top, the MWD tool 400 may have a modulator 410 (or mud pulser) that is used to transmit data to the surface via pressure pulses in the drilling fluid. The top of the MWD tool 400 may contain a fishing head 412, which allows the tool 400 to be recovered from the drill collar 404 without removing any drill pipe from the well. Notably, the fishing head 412 may also be used to lower a new MWD tool into the drill string. For example, if the MWD tool 400 fails during a drilling job, a wireline cable with an overshot may be run into the well and used to retrieve the failed MWD tool 400, as is understood by one with ordinary skill in the art. A replacement MWD tool may then be lowered on a wireline cable to seat in the same drill collar 404. Because the sensors in a retrievable MWD tool 400 reside in the pressure housing, it may not be possible to mount sensors in the drill collar 404 with wires simply connecting the sensors in the drill collar 404 to the electronics in the pressure housing 402.

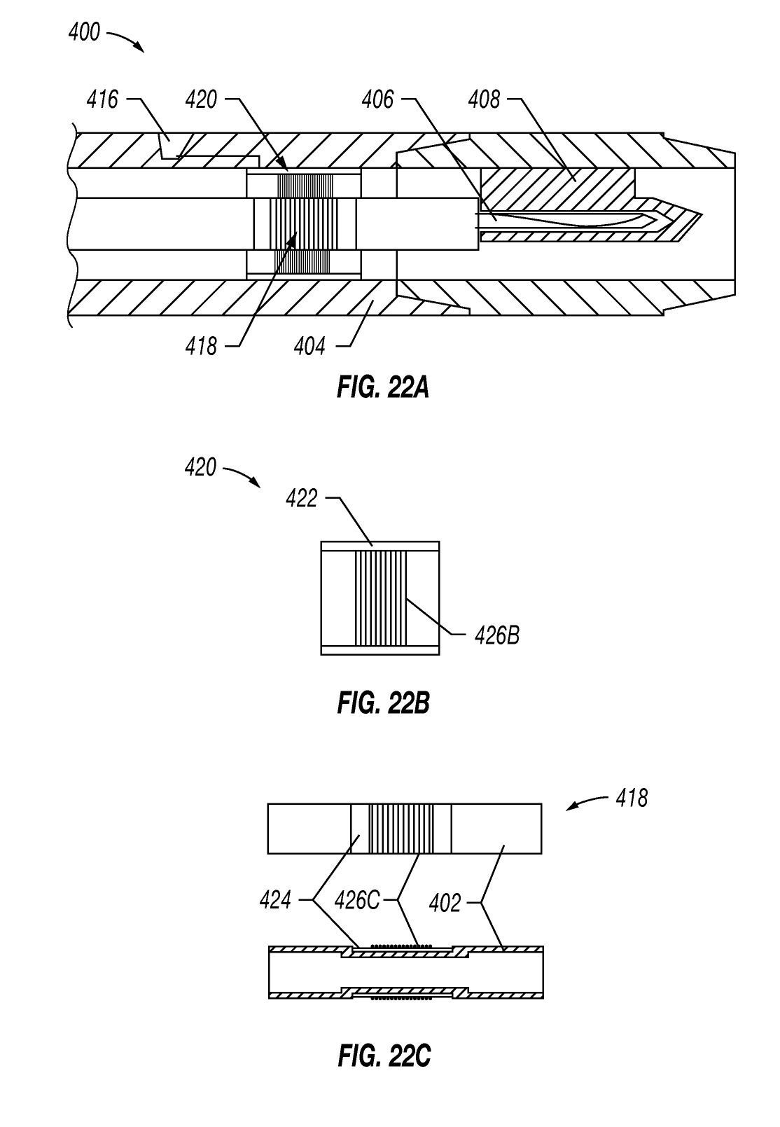

Notably, referring to FIG. 21, sensors in the drill collar 404 may be powered from the retrievable MWD tool 400. The power transfer from the MWD tool 400 to the sensors 416 in the drill collar 404 may be accomplished via an inner coil 418 and an outer coil 420. The inner coil 418 may be wound on the outside of the pressure housing 402 and the outer coil 420 may be mounted to the inner diameter (“ID”) of the drill collar 404. The inner and outer coils 418, 420 may include ferrite cores 422, 424 as illustrated in FIG. 22. These coils 418, 420 would operate similar to coils 232, 234 described above in connection with FIGS. 5A-5B. It is envisioned that the electrical and electromagnetic properties of the two coils 418, 420 shown in FIGS. 20 and 21 may have different values than FIGS. 5A-5B, but the circuitry and principles for determining the optimum values may be the same.

In general, power may be efficiently transferred from an inner coil 418 to an outer coil 420, which allows for sensors 416 in the drill collar 404 to be powered by a turbine or batteries mounted in the bore of the drill collar. Likewise, power can be transferred from the drill collar 404 to electronics mounted inside the drill collar bore. Data may also be transferred by modulating the frequency, phase, or amplitude of the power carrying signal. A low value for the coupling coefficient may be offset by resonating the two coils at the same frequency, by designing coils with high quality factors, and/or by matching impedances between of the source and of the load to the system.

As noted previously, the system described above mentions how power may flow from the rotary steerable system (“RSS”) 150 to the drill collar. One of ordinary skill in the art recognizes that power may easily flow in the other direction—from the drill collar to the RSS. The system may transmit power in either directions and/or in both directions as understood by one of ordinary skill in the art.

The method and system described herein may provide for efficient power transfer. According to one aspect, power may be transmitted between two coils where the two coils do not have to be in close proximity (see equation 1 discussed above) in which k may be less than (<1) or equal to one. Another potential distinguishing aspect of the described method and system includes resonating the power transmitting coil with a high quality factor (see equation 3 discussed above) in which Q may be greater than (>) or equal to 10. Another distinguishing aspect of the system and method may include resonating the power transmitting coil with series capacitance (see equation 2 listed above).

Other unique aspects of the described method and system may include resonating the power transmitting coil with parallel capacitance and resonating the power receiving coil with a high quality factor Q (see equation 3) in which Q is greater than (>) or equal to 10. Other unique features of the described method and system may include resonating the power receiving coil with series capacitance (see equation 2 discussed above) as well as resonating the power receiving coil with parallel capacitance.

Another unique feature of the method and system described herein may include resonating the transmitting coil and the receiving coil at similar frequencies (see equation 2 described above) as well as matching the impedance of the power supply to the impedance looking toward the transmitting coil (see equation 10 described above). Another distinguishing feature of the described method and system may include matching the impedance of the load to the impedance looking back toward the receiving coil (see equation 12 described above). An additional distinguishing aspect of the described method and system may include using magnetic material to increase the coupling efficiency between the transmitting and the receiving coils.

FIGS. 22A-22C illustrate detailed views of the inner and outer coil configuration used in the embodiment of FIG. 21. Referring to the FIG. 22 illustrations, the described method and system may include a power transmitting coil 418 that includes wire 426C wrapped around a ferrite core 424 (for example, see FIG. 22C). Meanwhile, the power receiving coil 420 may include a wire 426B located inside a ferrite core 422 (see FIG. 22B). According to another aspect, the power transmitting coil 418 may be located inside the power receiving coil 420 (see FIG. 22).

Although a few embodiments have been described in detail above, those skilled in the art will readily appreciate that many modifications are possible in the embodiments without materially departing from this disclosure. Accordingly, such modifications are intended to be included within the scope of this disclosure as defined in the following claims.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, sixth paragraph for any limitations of any of the claims herein, except for those in which the claim expressly uses the words ‘means for’ together with an associated function.

What is claimed is:

1. A method for transmitting electrical power to a sensor in a drill collar of a rotary steerable system from a power source in a cartridge that resides within the drill collar, the method comprising:
inductively coupling a pair of coils comprising a primary coil and a secondary coil, wherein:
the primary coil is a mandrel coil associated with the cartridge and the secondary coil is an annular coil associated with the drill collar; and
the primary coil is substantially positioned within a space defined by the secondary coil;
providing power from the power source to the primary coil via a wired connection, wherein provision of the power to the primary coil causes power to be transmitted to the inductively coupled secondary coil; and
providing power from the secondary coil to the sensor via a wired connection.

2. The method of claim 1, wherein the coupling coefficient, k, of the pair of coils is determined as k=M/\sqrt{L₁L₂}, wherein k is the coupling coefficient of the coils, M is the mutual inductance between the coils, and L₁ and L₂ are the self-inductances of the primary and secondary coils, respectively.

3. The method of claim 2, wherein the coils are loosely coupled such that k is less than or equal to approximately 0.9.

4. The method of claim 1, further comprising resonantly tuning the pair of coils with capacitors such that the coils resonate at approximately the same frequency.

5. The method of claim 4, wherein each coil is resonantly tuned with a capacitor such that: f₁≈f₂, wherein
$${f}_{1} = \frac{1}{2 π \sqrt{{L}_{1} {C}_{1}}}$$
$$and$$
$${f}_{2} = \frac{1}{2 π \sqrt{{L}_{2} {C}_{2}}}$$
and f₁ and f₂ are the frequencies in Hertz of the respective coils, L₁ and L₂ are the self-inductances of the respective coils, and C₁ and C₂ are capacitances of tuning capacitors associated with the respective coils.

6. The method of claim 1, wherein a figure of merit, U, associated with the pair of coils is equal to or greater than 3.

7. The method of claim 6, wherein U is determined as U=k\sqrt{Q₁Q₂}, wherein
$${Q}_{1} = \frac{2 π {f}_{1} {L}_{1}}{{R}_{1}}$$
$$and$$
$${Q}_{2} = \frac{2 π {f}_{2} {L}_{2}}{{R}_{2}}$$
and Q₁ and Q₂ are the quality factors associated with the respective coils, f₁ and f₂ are the frequencies in Hertz of the respective coils, L₁ and L₂ are the self-inductances of the respective coils, and R₁ and R₂ are the resistances of the respective coils.

8. The method of claim 1, wherein each of the pair of coils is associated with a high quality factor, Q, that is equal to or greater than 10.

9. The method of claim 1, further comprising approximately matching an impedance of the source, R_{S}, with an impedance of a load by setting:
R_{S}≈R₁\sqrt{1+k²Q₁Q₂},
wherein R₁ is the series resistance of the primary coil, k is the coupling coefficient of the pair of coils, Q₁ is the quality factor associated with primary coil and Q₂ is the quality factor associated with the secondary coil.

10. The method of claim 1, further comprising approximately matching an impedance of a load, R_{L}, with an impedance of the source by setting:
R_{L}≈R₂\sqrt{1+k²Q₁Q₂},
wherein R₂ is the series resistance of the secondary coil, k is the coupling coefficient of the pair of coils, Q₁ is the quality factor associated with primary coil and Q₂ is the quality factor associated with the secondary coil.

11. The method of claim 1, wherein the secondary coil comprises a wire wrapped on a cylinder comprised of ferrite.

12. The method of claim 1, wherein the primary coil comprises a wire wrapped on a core comprised of ferrite.

13. The method of claim 1, wherein the power transferred from the primary coil to the inductively coupled secondary coil comprises data in the form of a modulated amplitude, phase or frequency of a current that drives the primary coil.

14. A system for transmitting electrical power to a sensor in a drill collar of a rotary steerable system from a power source in a cartridge that resides within the drill collar, the system comprising:
an inductively coupled pair of coils comprising a primary coil and a secondary coil, wherein:
the primary coil is a mandrel coil associated with the cartridge and the secondary coil is an annular coil associated with the drill collar; and
the primary coil is substantially positioned within a space defined by the secondary coil;
a power source within the cartridge coupled to the primary coil via a wired connection and operable to provide power to the primary coil, wherein provision of the power to the primary coil causes power to be transmitted to the inductively coupled secondary coil; and
a wired connection operable to provide power from the secondary coil to the sensor.

15. The system of claim 14, wherein the coupling coefficient, k, of the pair of coils is less than or equal to 0.9.

16. The system of claim 14, wherein the pair of coils are resonantly tuned with a capacitor such that the coils resonate at approximately the same frequency.

17. The system of claim 14, wherein a figure of merit, U, associated with the pair of coils is equal to or greater than 3.

18. The system of claim 14, wherein each of the pair of coils is associated with a high quality factor, Q, that is equal to or greater than 10.

19. The system of claim 14, wherein the impedance of the source, R_{S}, is approximately matched with an impedance of a load by setting:
R_{S}≈R₁\sqrt{1+k²Q₁Q₂},
wherein R₁ is the series resistance of the primary coil, k is the coupling coefficient of the pair of coils, Q₁ is the quality factor associated with primary coil and Q₂ is the quality factor associated with the secondary coil.

20. The system of claim 14, wherein the impedance of a load, R_{L}, is approximately matched with an impedance of the source by setting:
R_{L}≈R₂\sqrt{1k²Q₁Q₂},
wherein R₂ is the series resistance of the secondary coil, k is the coupling coefficient of the pair of coils, Q₁ is the quality factor associated with primary coil and Q₂ is the quality factor associated with the secondary coil.

21. The system of claim of claim 14, comprising a first antenna mounted in a groove on the drill collar of the rotary steerable system, the first short hop antenna being operatively coupled to transmitting and receiving electronics powered by the secondary coil, wherein the first antenna is configured to transmit data by electromagnetic telemetry using short hop communication to a second antenna mounted in a grove on a drill collar of a measure-while-drilling (MWD) tool.

22. The system of claim 21, wherein the first antenna and the second antenna are separated by at least fifty feet.

23. A method for transmitting electrical power to a sensor in a drill collar of a measure-while-drilling tool from a power source that resides within the drill collar, the method comprising:
inductively coupling a pair of coils comprising a primary coil and a secondary coil, wherein the primary coil is wound about a pressure housing disposed in the drill collar and the secondary coil is mounted on the inner diameter of the drill collar, wherein the primary coil is substantially positioned within a space defined by the secondary coil;
providing power from the power source to the primary coil via a wired connection, wherein provision of the power to the primary coil causes power to be transmitted to the inductively coupled secondary coil; and
providing power from the secondary coil to the sensor via a wired connection.

24. The method of claim 23, wherein the coupling coefficient, k, of the pair of coils is determined as k=M/\sqrt{L₁L₂}, wherein k is the coupling coefficient of the coils, M is the mutual inductance between the coils, and L₁ and L₂ are the self-inductances of the primary and secondary coils, respectively, and wherein the primary and secondary coils are loosely coupled such that k is less than or equal to approximately 0.9.

25. The method of claim 23, wherein the pair of coils are tuned with capacitors such that the coils resonate at approximately the same frequency f₁≈f₂, wherein
$${f}_{1} = \frac{1}{2 π \sqrt{{L}_{1} {C}_{1}}}$$
$$and$$
$${f}_{2} = \frac{1}{2 π \sqrt{{L}_{2} {C}_{2}}}$$
and f₁ and f₂ are the frequencies in Hertz of the respective coils, L₁ and L₂ are the self-inductances of the respective coils, and C₁ and C₂ are capacitances of tuning capacitors associated with the respective coils.

26. The method of claim 23, wherein a figure of merit, U, is determined as U=k\sqrt{Q₁Q₂}, wherein
$${Q}_{1} = \frac{2 π {f}_{1} {L}_{1}}{{R}_{1}}$$
$$and$$
$${Q}_{2} = \frac{2 π {f}_{2} {L}_{2}}{{R}_{2}}$$
and Q₁ and Q₂ are the quality factors associated with the respective coils, f₁ and f₂ are the frequencies in Hertz of the respective coils, L₁ and L₂ are the self-inductances of the respective coils, and R₁ and R₂ are the resistances of the respective coils, wherein the U associated with the pair of coils is equal to or greater than 3.

27. The method of claim 26, wherein each of the pair of coils is associated with a high quality factor, Q, that is equal to or greater than 10.
